(19) United States
(12) Patent Application Publication
(10) Pub. No.: US 2020/0241032 A1
(43) Pub. Date: Jul. 30, 2020

(54) INERTIAL SENSOR, ELECTRONIC DEVICE, AND VEHICLE

(71) Applicant: SEIKO EPSON CORPORATION, Tokyo (JP)

(72) Inventor: Kazuyuki NAGATA, MINOWA-MACHI (JP)

(21) Appl. No.: 16/750,535

(22) Filed: Jan. 23, 2020

(30) Foreign Application Priority Data
Jan. 25, 2019 (JP) 2019-011483

(51) Int. Cl. G01P 15/08; B60W 50/04

(52) U.S. Cl. CPC G01P 15/08; G01P 2015/0871; B60W 50/045

(57) ABSTRACT

An inertial sensor includes, assuming an X-axis, a Y-axis, and a Z-axis, a substrate, a movable body that swings around a swing axis along the Y-axis, a fixed portion that supports the movable body and is fixed to the substrate, and a stopper that is fixed to the substrate and regulates rotational displacement of the movable body around the Z-axis by coming into contact with the movable body, and in which the stopper includes a first stopper facing the movable body along the Y-axis and having a separation distance L1 from the swing axis and a second stopper facing the movable body along the Y-axis and having a separation distance L2 shorter than the separation distance L1 from the swing axis, and the movable body comes into contact with the first stopper and the second stopper simultaneously when the movable body is rotationally displaced.

The present application is based on, and claims priority from JP Application Serial Number 2019-011483, filed Jan. 25, 2019, the disclosure of which is hereby incorporated by reference herein in its entirety.

### BACKGROUND

### 1. Technical Field

The present disclosure relates to an inertial sensor, an electronic device, and a vehicle.

### 2. Related Art

For example, an inertial sensor described in JP-A-2015-017886 is a sensor that can measure acceleration in the Z-axis direction, and includes a substrate, a movable body that swings in a seesaw manner around a swing axis along the Y-axis direction with respect to the substrate, and a fixed detection electrode provided on the substrate. The movable body includes a first movable portion and a second movable portion that are provided with the swing axis interposed therebetween and have different rotational moments around the swing axis. The fixed detection electrode includes a first fixed detection electrode disposed on the substrate and facing the first movable portion of a movable portion and a second fixed detection disposed on the substrate and facing the second movable portion of the movable portion.

In the inertial sensor having such a configuration, when acceleration in the Z-axis direction is applied, the movable body swings in a seesaw manner around the swing axis, and accordingly, capacitance between the first movable portion and the first fixed detection electrode and capacitance between the second movable portion and the second fixed detection electrode change in opposite phases. For that reason, the acceleration in the Z-axis direction can be measured based on this change in capacitance.

The inertial sensor described in JP-A-2015-017886 includes a plurality of stoppers that are fixed to the substrate and suppress rotational displacement of the movable body. However, in JP-A-2015-017886, a specific configuration of each stopper, in particular, a separation distance between each stopper and the movable body is unknown, and the separation distance between each stopper and the movable body appears to be equal from the drawing. Since the plurality of stoppers have different distances from the swing axis, if the distances from the movable body are equal to each other, when the movable body is displaced, only the stopper distal from the swing axis comes into contact with the movable body, and the movable body does not come into contact with a stopper which is more proximal than the distal stopper. For that reason, some stoppers cannot exert their functions, and it is difficult to sufficiently improve impact resistance of the inertial sensor.

### SUMMARY

An inertial sensor according to an aspect of the disclosure includes a substrate, a movable body that swings around a swing axis along a Y-axis, a fixed portion that supports the movable body and is fixed to the substrate, and a stopper that is fixed to the substrate and regulates rotational displacement of the movable body around a Z-axis by coming into contact with the movable body, and in which the stopper includes a first stopper facing the movable body along the Y-axis and having a separation distance L1 from the swing axis and a second stopper facing the movable body along the Y-axis and having a separation distance L2 shorter than the separation distance L1 from the swing axis, and the movable body comes into contact with the first stopper and the second stopper simultaneously when the movable body is rotationally displaced, and in which an X-axis, the Y-axis, and the Z-axis are three axes orthogonal to each other.

An inertial sensor according to another aspect of the present disclosure includes a substrate, a movable body that swings around a swing axis along a Y-axis, a fixed portion that supports the movable body and is fixed to the substrate, and a stopper that is fixed to the substrate and regulates rotational displacement of the movable body around a Z-axis by coming into contact with the movable body, and in which the stopper includes a first stopper facing the movable body along the Y-axis and having a separation distance L1 from the swing axis and a second stopper facing the movable body along the Y-axis and having a separation distance L2 shorter than the separation distance L1 from the swing axis, and the movable body comes into contact with the second stopper prior to the first stopper when the movable body is rotationally displaced, and in which an X-axis, the Y-axis, and the Z-axis are three axes orthogonal to each other.

### BRIEF DESCRIPTION OF THE DRAWINGS

FIG. 1 is a plan view illustrating an inertial sensor according to a first embodiment.

FIG. 2 is a cross-sectional view taken along line II-II in FIG. 1.

FIG. 3 is a plan view of the inertial sensor.

FIG. 4 is a plan view for explaining a function of a stopper.

FIG. 5 is another plan view for explaining the function of the stopper.

FIG. 6 is a plan view illustrating an inertial sensor according to a second embodiment.

FIG. 7 is a plan view illustrating an inertial sensor according to a third embodiment.

FIG. 8 is a plan view illustrating an inertial sensor according to a fourth embodiment.

FIG. 9 is a plan view illustrating a modification example of FIG. 8.

FIG. 10 is a plan view illustrating an inertial sensor according to a fifth embodiment.

FIG. 11 is a plan view of the inertial sensor.

FIG. 12 is a plan view illustrating a smartphone as an electronic device according to a sixth embodiment.

FIG. 13 is an exploded perspective view illustrating an inertia measurement device as an electronic device according to a seventh embodiment.

FIG. 14 is a perspective view of a substrate included in the inertia measurement device illustrated in FIG. 13.

FIG. 15 is a block diagram illustrating an entire system of a vehicle positioning device as an electronic device according to an eighth embodiment.

FIG. 16 is a diagram illustrating an action of the vehicle positioning device illustrated in FIG. 15.

FIG. 17 is a perspective view illustrating a vehicle according to a ninth embodiment.

### DESCRIPTION OF EXEMPLARY EMBODIMENTS

Hereinafter, an inertial sensor, an electronic device, and a vehicle according to the present disclosure will be described in detail based on embodiments illustrated in the accompanying drawings.

### First Embodiment

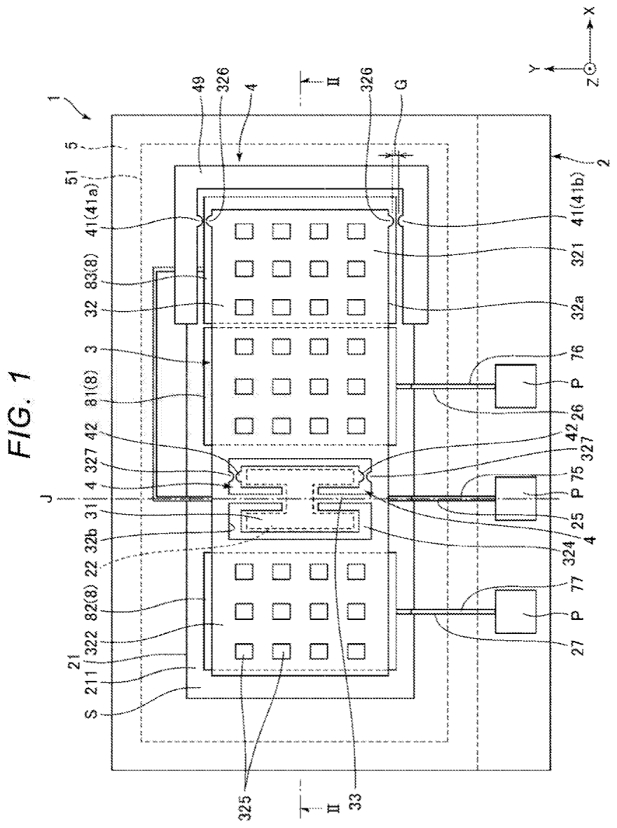

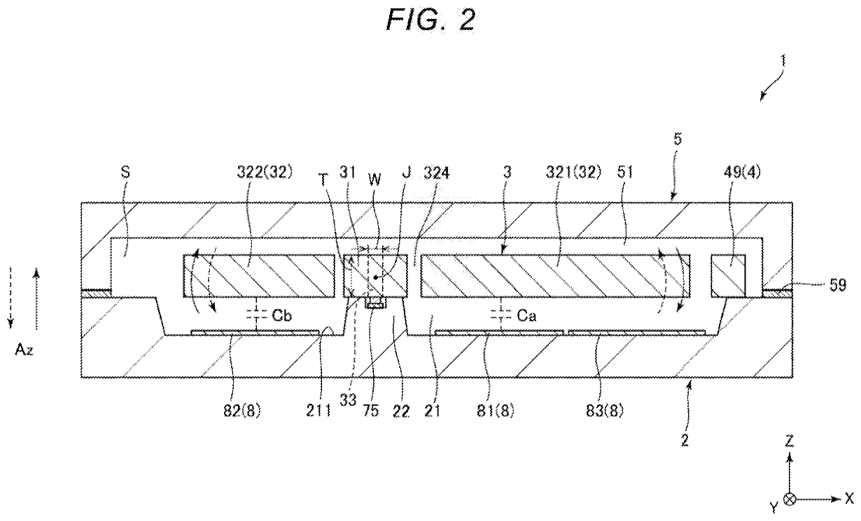

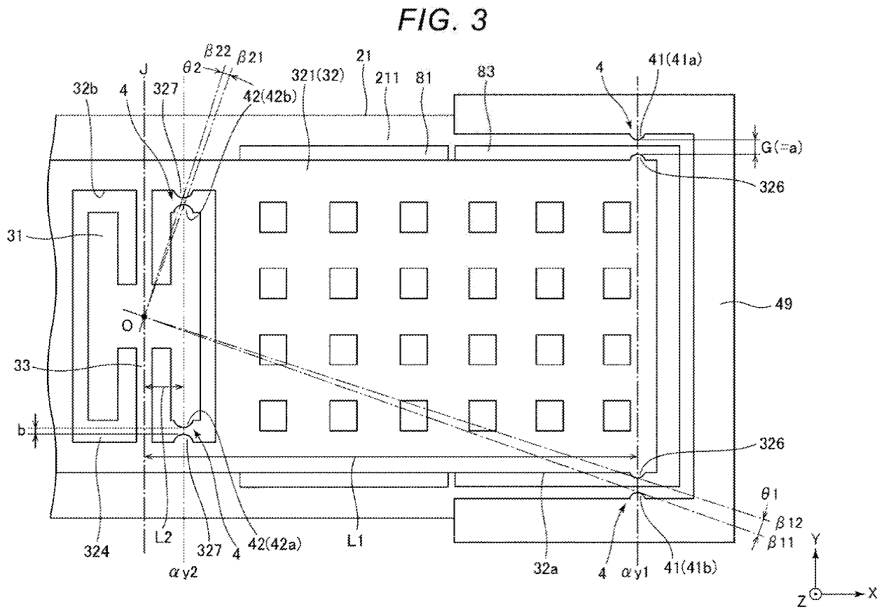

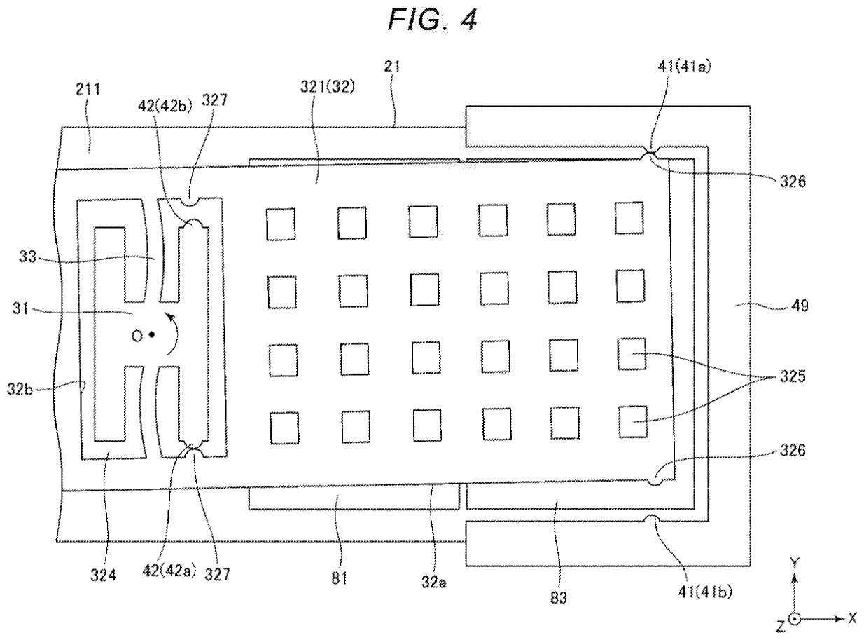

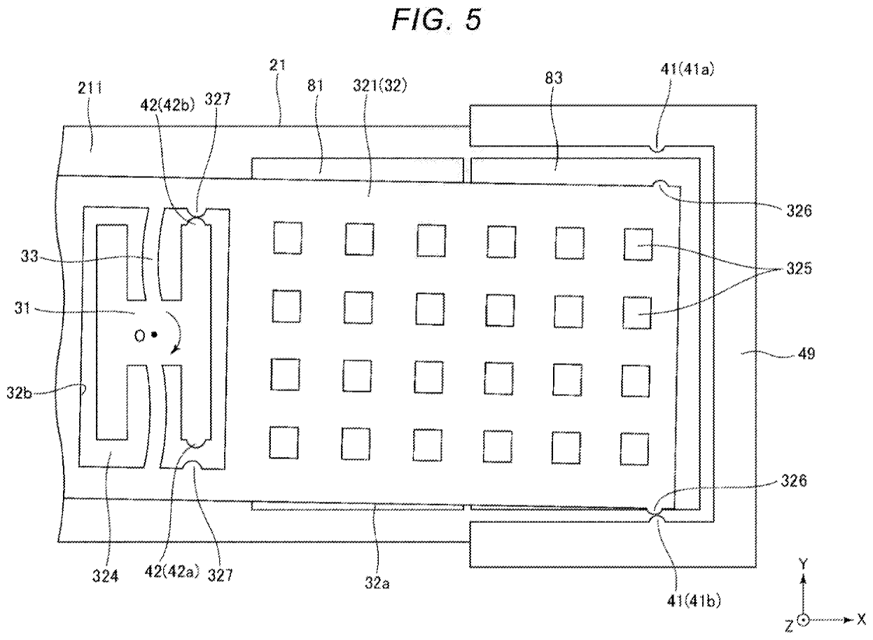

FIG. 1 is a plan view illustrating an inertial sensor according to a first embodiment. FIG. 2 is a cross-sectional view taken along line II-II in FIG. 1. FIG. 3 is a plan view of the inertial sensor. FIGS. 4 and 5 are plan views for explaining a function of a stopper, respectively.

Hereinafter, for convenience of explanation, three axes orthogonal to each other are referred to as an X-axis, a Y-axis, and a Z-axis. A direction along the X-axis, that is, a direction parallel to the X-axis is referred to as an “X-axis direction”, a direction along the Y-axis is referred as a “Y-axis direction”, and a direction along the Z-axis is referred as a “Z-axis direction”. A tip end side of the arrow of each axis is also referred to as a “plus side”, and the opposite side is also referred to a “minus side”. In addition, the plus side in the Z-axis direction is also referred to as “upper”, and the minus side in the Z-axis direction is also referred to as “lower”. In the specification of the present application, the term “orthogonal to” includes not only a case where constituent elements intersect at 90° but also a case where the constituent elements intersect at an angle slightly inclined from 90°, for example, within a range of 90°±5°. Similarly, “parallel” includes not only a case where an angle between two constituent elements is 0° but also a case where two constituent elements have a difference within a range of about ±5°.

The inertial sensor 1 illustrated in FIG. 1 is an acceleration sensor that measures acceleration Az in the Z-axis direction. Such an inertial sensor 1 includes a substrate 2, a sensor element 3 disposed on the substrate 2, a stopper 4 that suppresses unnecessary displacement of the sensor element 3, and a lid 5 bonded to the substrate 2 to cover the sensor element 3 and the stopper 4.

As illustrated in FIG. 1, the substrate 2 has a concave portion 21 that opens to the upper surface side. The concave portion 21 is formed to be larger than the sensor element 3 so as to enclose the sensor element 3 in plan view from the Z-axis direction. As illustrated in FIG. 2, the substrate 2 has a protrusion-like mount 22 provided so as to protrude from a bottom surface 211 of the concave portion 21. The sensor element 3 is bonded to the upper surface of the mount 22. As illustrated in FIG. 1, the substrate 2 has grooves 25, 26, and 27 that are open to the upper surface side.

As such a substrate 2, for example, a glass substrate made of a glass material containing alkali metal ions that are movable ions such as Na⁺, specifically, borosilicate glass such as Tempax glass and Pyrex glass (both are registered trademark) can be used. However, the substrate 2 is not particularly limited, and for example, a silicon substrate or a ceramic substrate may be used.

As illustrated in FIG. 1 an electrode 8 is provided on the substrate 2. The electrode 8 includes a first fixed detection electrode 81, a second fixed detection electrode 82, and a dummy electrode 83 disposed on a bottom surface 211 of the concave portion 21. The substrate 2 includes wirings 75, 76, 77 disposed in the grooves 25, 26, and 27.

One end portions of the wirings 75, 76, and 77 are exposed to the outside of the lid 5, respectively, and function as electrode pads P that makes electrical connection with an external apparatus. The wiring 75 is electrically connected to the sensor element 3, the stopper 4, and the dummy electrode 83, the wiring 76 is electrically connected to the first fixed detection electrode 81, and the wiring 77 is connected to the second fixed detection electrode 82.

As illustrated in FIG. 2, the lid 5 has a concave portion 51 which opens to the lower surface. The lid 5 is bonded to the upper surface of the substrate 2 so as to accommodate the sensor element 3 and the stopper 4 in the concave portion 51. An accommodation space S in which the sensor element 3 and the stopper 4 are accommodated is formed by the lid 5 and the substrate 2. The accommodation space S is an airtight space, and may be filled with an inert gas such as nitrogen, helium, or argon, and is preferably at almost atmospheric pressure at a use temperature, for example, about −40° C. to 120° C. However, the atmosphere of the accommodation space S is not particularly limited, and may be, for example, a reduced pressure state or a pressurized state.

As such a lid 5, for example, a silicon substrate can be used. However, the lid 5 is not particularly limited, and for example, a glass substrate or a ceramic substrate may be used as the lid 5. A bonding method between the substrate 2 and the lid 5 is not particularly limited, and may be appropriately selected depending on the materials of the substrate 2 and the lid 5, and for example, anodic bonding, activated bonding in which bonding surfaces activated by plasma irradiation are bonded, bonding by a bonding material such as glass frit, and diffusion bonding for bonding metal films formed on the upper surface of the substrate 2 and the lower surface of the lid 5 can be used. In the first embodiment, the substrate 2 and the lid 5 are bonded through a glass frit 59 made of low melting point glass.

The sensor element 3 is formed by etching and patterning a conductive silicon substrate doped with, for example, impurities such as phosphorus (P), boron (B), arsenic (As) or the like by the Bosch process which is a deep groove etching technique. As illustrated in FIG. 1, the sensor element 3 includes a fixed portion 31 bonded to the upper surface of the mount 22, and a movable body 32 that can swing around a swing axis J along the Y-axis with respect to the fixed portion 31, and a beam 33 that couples the fixed portion 31 and the movable body 32. The mount 22 and the fixed portion 31 are anodic bonded, for example.

The movable body 32 has a rectangular shape with the X-axis direction as the longitudinal direction in plan view from the Z-axis direction. The movable body 32 includes a first movable portion 321 and a second movable portion 322 that are disposed with the swing axis J parallel to the Y-axis interposed therebetween in plan view from the Z-axis direction. The first movable portion 321 is positioned on the plus side in the X-axis direction with respect to the swing axis J, and the second movable portion 322 is positioned on the minus side in the X-axis direction with respect to the swing axis J. The first movable portion 321 is longer in the X-axis direction than the second movable portion 322, and rotational moment around the swing axis J when acceleration Az is applied is greater than that of the second movable portion 322. Due to this difference in rotational moment, the movable body 32 swings in a seesaw manner around the swing axis J when the acceleration Az is applied. The seesaw swinging means that the second movable portion 322 is displaced to the minus side in the Z-axis direction when the first movable portion 321 is displaced to the plus side in the Z-axis direction, and conversely, the second movable portion 322 is displaced to the plus side in the Z-axis direction when the first movable portion 321 is displaced to the minus side in the Z-axis direction.

The movable body 32 has a plurality of through-holes 325 that penetrate in the thickness direction. The movable body 32 has an opening 324 positioned between the first movable portion 321 and the second movable portion 322. The fixed portion 31 and the beam 33 are disposed in the opening 324. As such, miniaturization of the sensor element 3 can be achieved by disposing the fixed portion 31 and the beam 33 inside the movable body 32. However, the through-hole 325 may be omitted. Disposition of the fixed portion 31 and the beam 33 is not particularly limited, and the fixed portion 31 and the beam 33 may be positioned outside the movable body 32 as in another embodiment described later, for example.

The beam 33 extends along the Y-axis direction and torsionally deforms around its central axis, thereby allowing the movable body 32 to swing around the swing axis J. As illustrated in FIG. 2, the beam 33 has a thickness T in the direction along the Z-axis greater than a width W in the direction along the X-axis. That is, W<T. With this configuration, torsional deformation of the beam 33 around the central axis is easy and the beam 33 is suppressed from being bent in the Z-axis direction. For that reason, the movable body 32 can be supported in a stable posture, and when the acceleration Az is applied, the movable body 32 can be swung more smoothly. Furthermore, since the movable body 32 is easily rotated and displaced around the Z-axis, the effect of providing the stopper 4 is further enhanced. However, the shape of the beam 33 is not limited to this, and may be W T, for example.

Returning to the description of the electrode 8 disposed on the bottom surface 211 of the substrate 2, as illustrated in FIGS. 1 and 2, the first fixed detection electrode 81 is disposed to face the base end portion of the first movable portion 321, the second fixed detection electrode 82 is disposed to face the second movable portion 322, and the dummy electrode 83 is disposed to face the tip end portion of the first movable portion 321. In other words, in plan view from the Z-axis direction, the first fixed detection electrode 81 is disposed so as to overlap the base end portion of the first movable portion 321, the second fixed detection electrode 82 is disposed so as to overlap the second movable portion 322, and the dummy electrode 83 is disposed so as to overlap the tip end portion of the first movable portion 321.

When the inertial sensor 1 is driven, a driving voltage is applied to the sensor element 3 through the wiring 75, the first fixed detection electrode 81 is connected to a QV amplifier through the wiring 76, and the second fixed detection electrode 82 is connected to another QV amplifier through the wiring 77. With this configuration, capacitance Ca is formed between the first movable portion 321 and the first fixed detection electrode 81, and capacitance Cb is formed between the second movable portion 322 and the second fixed detection electrode 82.

When the acceleration Az is applied to the inertial sensor 1, the movable body 32 swings in a seesaw manner centering around the swing axis J. Due to the seesaw swinging of the movable body 32, a gap between the first movable portion 321 and the first fixed detection electrode 81 and a gap between the second movable portion 322 and the second fixed detection electrode 82 change in opposite phases, and the capacitances Ca and Cb change in opposite phases to each other accordingly. For that reason, the inertial sensor 1 can measure the acceleration Az based on changes in the capacitances Ca and Cb.

The stopper 4 has a function to suppress unnecessary displacement other than the seesaw swinging around the swing axis J of the movable body 32 as described above, that is, detection vibration, in particular, rotational displacement around the Z-axis centering around the fixed portion 31, that is, rotational displacement in the X-Y plane. In the first embodiment, as described above, since the beam 33 has a cross-sectional shape with the width W<the thickness T, the beam 33 is easily elastically deformed in the X-axis direction and rotational displacement around the Z-axis of the movable body 32 is likely to occur. For that reason, by providing such a stopper 4, unnecessary displacement of the movable body 32 can be effectively controlled and damage to the sensor element 3 can be effectively suppressed. For that reason, the inertial sensor 1 having excellent mechanical strength is obtained.

Such a stopper 4 is formed by etching and patterning a conductive silicon substrate doped with, for example, impurities such as phosphorus (P), boron (B), arsenic (As) or the like by the Bosch process which is a deep groove etching technique. In particular, in the first embodiment, the sensor element 3 and the stopper 4 are collectively formed from the same silicon substrate. With this configuration, formation of the stopper 4 becomes easy.

As described above, the stopper 4 is electrically coupled to the wiring 75 in the same manner as the sensor element 3. For that reason, the stopper 4 and the sensor element 3 are at the same potential, and there is substantially no possibility that parasitic capacitance or electrostatic attraction force occurs between the stopper 4 and the sensor element 3. For that reason, it is possible to effectively suppress a decrease in measurement characteristics of the acceleration Az caused by the stopper. However, the present disclosure is not limited to this, and the stopper 4 may not be the same potential as the sensor element 3. For example, the stopper 4 may be at ground potential or may be electrically floating.

As illustrated in FIG. 3, the stopper 4 includes a first stopper 41 and a second stopper 42 that are different from each other in the separation distance from the swing axis J. The first stopper 41 is disposed side by side with the movable body 32 in the Y-axis direction, and the separation distance from the swing axis J is L1. In other words, the first stopper 41 faces the movable body 32 along the Y-axis direction, and the separation distance from the swing axis J is L1. The second stopper 42 is disposed side by side with the movable body 32 in the Y-axis direction, and the separation distance from the swing axis J is L2 shorter than L1. In other words, the second stopper 42 faces the movable body 32 along the Y-axis direction, and the separation distance from the swing axis J is L2. That is, L1>L2. The separation distance from the swing axis J is a distance at which the distance from the swing axis J is closest.

The first stopper 41 is positioned outside the movable body 32 and faces an outer peripheral surface 32a of the movable body 32. By disposing the first stopper 41 outside the movable body 32, the degree of freedom in designing the first stopper 41 is increased. The first stopper 41 is supported by a support portion 49 that is bonded to the upper surface of the substrate 2. A protruding portion 326 protruding from the outer peripheral surface 32a is provided at a portion facing the first stopper 41 of the movable body 32, and when the movable body 32 is rotationally displaced around the Z-axis, the protruding portion 326 comes into contact with the first stopper 41. Both the first stopper 41 and the protruding portion 326 have shapes in which tip end portions thereof are rounded, and are less likely to be chipped or cracked during contact. However, the shapes of the first stopper 41 and the protruding portion 326 are not particularly limited, and the protruding portion 326 may be omitted.

The first stopper 41 faces the tip end portion of the first movable portion 321. The tip end portion of the first movable portion 321 is positioned farthest from the swing axis J in the movable body 32, and has the largest amount of displacement when the rotational displacement around the Z-axis described above occurs. For that reason, by disposing the first stopper 41 so as to face the tip end portion of the first movable portion 321, the movable body 32 can easily come into contact with the first stopper 41, and the effect as a stopper can be more reliably exhibited. Further, since a gap G between the movable body 32 and the first stopper 41 can be made relatively large, formation of the first stopper 41 and gap management become easy. The size of the gap G is not particularly limited, and may vary depending on the size of the sensor element 3 or the like, but can be set to about 1 to 5 μm, for example.

A pair of the first stoppers 41 is provided with the movable body 32 interposed therebetween. One first stopper 41a is positioned on the plus side in the Y-axis direction with respect to the movable body 32, and the other first stopper 41b is positioned on the minus side in the Y-axis direction with respect to the movable body 32. By disposing the first stopper 41 on both sides of the movable body 32, rotational displacement in a forward direction and rotational displacement in an opposite direction around the Z-axis of the movable body 32 can be respectively regulated. The pair of first stoppers 41a and 41b is disposed side by side in the Y-axis direction. That is, the pair of first stoppers 41a and 41b is positioned on a predetermined imaginary Y-axis αyl along the Y-axis. With this configuration, the design of the first stopper 41 becomes easy.

The second stopper 42 is positioned inside the movable body 32, specifically, in the opening 324, and faces an inner edge of the movable body 32, that is, an inner peripheral surface 32b of the opening 324. As such, by disposing the second stopper 42 inside the movable body 32, a region inside the movable body 32 can be effectively used and miniaturization of the inertial sensor 1 can be achieved.

The second stopper 42 is supported by the fixed portion 31. A protruding portion 327 protruding from an inner peripheral surface 32b is provided at a portion facing the second stopper 42 of the movable body 32, and when the movable body 32 is rotationally displaced around the Z-axis, the protruding portion 327 comes into contact with the second stopper 42. Both the second stopper 42 and the protruding portion 327 have shapes in which tip end portions thereof are rounded, and are less likely to be chipped or cracked during contact. However, the shapes of the second stopper 42 and the protruding portion 327 are not particularly limited, and the protruding portion 327 may be omitted.

A pair of second stoppers 42 is provided with the fixed portion 31 interposed therebetween. One second stopper 42a is positioned on the minus side in the Y-axis direction with respect to the fixed portion 31 and the other second stopper 42b is positioned on the plus side in the Y-axis direction with respect to the fixed portion 31. By disposing the second stopper 42 on both sides of the fixed portion 31, rotational displacement in a forward direction and rotational displacement in an opposite direction around the Z-axis of the movable body 32 can be respectively regulated. The pair of second stoppers 42a and 42b is disposed side by side in the Y-axis direction. That is, the pair of second stoppers 42a and 42b is positioned on a predetermined imaginary Y-axis αy2 along the Y-axis. With this configuration, the design of the second stoppers 42 becomes easy.

In the stopper 4 having such a configuration, as illustrated in FIG. 4, when the movable body 32 is rotationally displaced in the forward direction around the Z-axis, the movable body 32 comes into contact with the first stopper 41a and the second stopper 42a simultaneously. In contrast, as illustrated in FIG. 5, when the movable body 32 is rotationally displaced in the opposite direction around the Z-axis, the movable body 32 comes into contact with the first stopper 41b and the second stopper 42b simultaneously. As such, when the movable body 32 comes into contact with the first and second stoppers 41 and 42 simultaneously, each of the first and second stoppers 41 and 42 can exert its function as a stopper and can more reliably regulate the rotational displacement of the movable body 32. When the movable body 32 comes into contact with the first and second stoppers 41 and 42 simultaneously, the impact at the time of contact is alleviated and damage to the stopper 4 and the movable body 32 can be suppressed. The term “simultaneously” described above means to include not only a case where the contact time between the movable body 32 and the first stopper 41 and the contact time between the movable body 32 and the second stopper 42 are the same time, but also a case where there is a slight deviation between these contact times that may occur due to manufacturing variations or the like, for example, a deviation within ±0.1 seconds.

Here, as illustrated in FIG. 3, when the center of the rotational displacement around the Z-axis of the movable body 32 is O, an angle θ1 formed by a line segment β11 connecting the center O and a contact point of the first stopper 41 with the protruding portion 326 and a line segment β12 connecting the center O and a contact point of the protruding portion 326 with the first stopper 41 is equal to an angle θ2 formed by a line segment β21 connecting the center O and a contact point of the second stopper 42 with the protruding portion 327 and a line segment β22 connecting the center O and a contact point of the protruding portion 327 with the second stopper 42. That is, θ1=θ2. By satisfying such a relationship, as described above, the movable body 32 can be configured such that the movable body 32 comes into contact with the first and second stoppers 41 and 42 simultaneously when the movable body 32 is rotationally displaced around the Z-axis. The expression “θ1=θ2” means to include not only a case where θ1 coincides with θ2, but also a case where there is a slight deviation between θ1 and θ2 that may occur due to manufacturing variations, for example, within ±20%, preferably within ±10%.

As illustrated in FIG. 3, in plan view from the Z-axis direction, when the separation distance from the swing axis J to the first stopper 41 is L1, the separation distance between the first stopper 41 and the protruding portion 326 is a, the separation distance from the swing axis J to the second stopper 42 is L2, and the separation distance between the second stopper 42 and the protruding portion 327 is b, b/a is equal to L2/L1. That is, b/a=L2/L1. By satisfying such a relationship, as described above, the movable body 32 can be configured such that the movable body 32 comes into contact with the first and second stoppers 41 and 42 simultaneously when the movable body is rotationally displaced around the Z-axis. The expression “b/a=L2/L1” means to include not only a case where b/a coincide with and L2/L1, but also a case where there is a slight deviation between b/a and L2/L1 that may occur due to manufacturing variation, for example, within ±20%, preferably within ±10%.

The inertial sensor 1 of the first embodiment has been described as above. As described above, such an inertial sensor 1 includes, assuming that three axes orthogonal to each other are an X-axis, a Y-axis, and a Z-axis, the substrate 2, the movable body 32 that swings around the swing axis J along the Y-axis, the fixed portion 31 that supports the movable body 32 and is fixed to the substrate 2, and the stopper 4 that is fixed to the substrate 2 and regulates rotational displacement around the Z-axis of the movable body 32 by being contacted with the movable body 32. The stopper 4 includes the first stopper 41 facing the movable body 32 along the Y-axis and having a separation distance L1 from the swing axis J and the second stopper 42 facing the movable body 32 along the Y-axis and having a separation distance L2 shorter than the separation distance L1 from the swing axis J. The movable body 32 comes into contact with the first stopper 41 and the second stopper 42 simultaneously when the movable body 32 is rotationally displaced around the Z-axis. When the movable body 32 comes into contact with the first and second stoppers 41 and 42 simultaneously, each of the first and second stoppers 41 and 42 can exert its function as a stopper and can more reliably regulate the rotational displacement of the movable body 32. When the movable body 32 comes into contact with the first and second stoppers 41 and 42 simultaneously, the impact at the time of contact is alleviated and damage to the stopper 4 and the movable body 32 can be suppressed. Accordingly, the inertial sensor 1 having excellent mechanical strength is obtained.

As described above, the inertial sensor 1 includes the beam 33 that couples the fixed portion 31 and the movable body 32. The beam 33 has a thickness T in the direction along the Z-axis greater than the width Win the direction along the X-axis. With this configuration, torsional deformation of the beam 33 around the central axis is easy and the beam 33 is suppressed from being bent in the Z-axis direction. For that reason, the movable body 32 can be supported in a stable posture, and when the acceleration Az is applied, the movable body 32 can be swung more smoothly. The movable body 32 is easily rotated and displaced around the Z-axis, the effect of providing the stopper 4 is further enhanced.

As described above, each of the first stopper 41 and the second stopper 42 is provided in plural along the Y-axis, and two first stoppers 41 and two second stoppers 42 are provided in the first embodiment. With this configuration, the rotational displacement of the movable body 32 in the forward direction and the rotational displacement thereof in the reverse direction around the Z-axis can be regulated. The design of the first stopper 41 and the second stopper 42 also becomes easy.

As described above, one of the first stopper 41 and the second stopper 42 is positioned outside the movable body 32, and the other is positioned inside the movable body 32. In the first embodiment, the first stopper 41 is positioned outside the movable body 32 and the second stopper 42 is positioned inside the movable body 32. By disposing the first and second stoppers 41 and 42 in this way, miniaturization of the inertial sensor 1 can be achieved while increasing the degree of freedom in designing the stopper 4. That is, the degree of freedom in design is increased by the amount of one of the first and second stoppers 41 and 42 being outside the movable body 32 as compared with the case where both the first and second stoppers 41 and 42 are inside the movable body 32, and miniaturization of the inertial sensor 1 can be achieved by the amount of one of the first and second stoppers 41 and 42 being inside the movable body 32 as compared with the case where both of the second stoppers 41 and 42 are outside the movable body 32.

As described above, the movable body 32 includes the first movable portion 321 and second movable portion 322 that are disposed with the swing axis J interposed therebetween and have different rotational moments around the swing axis J. The inertial sensor 1 includes the first fixed detection electrode 81 disposed on the substrate 2 and facing the first movable portion 321 and the second fixed detection electrode 82 disposed on the substrate 2 and facing the second movable portion 322. According to such a configuration, the inertial sensor 1 can measure the acceleration Az in the Z-axis direction. Specifically, when the acceleration Az in the Z-axis direction is applied, the movable body 32 swings around the swing axis, and accordingly, the capacitance Ca is between the first movable portion 321 and the first fixed detection electrode 81 and the capacitance Cb between the second movable portion 322 and the second fixed detection electrode 82 change, and thus the acceleration Az can be measured based on the changes in the capacitances Ca and Cb.

### Second Embodiment

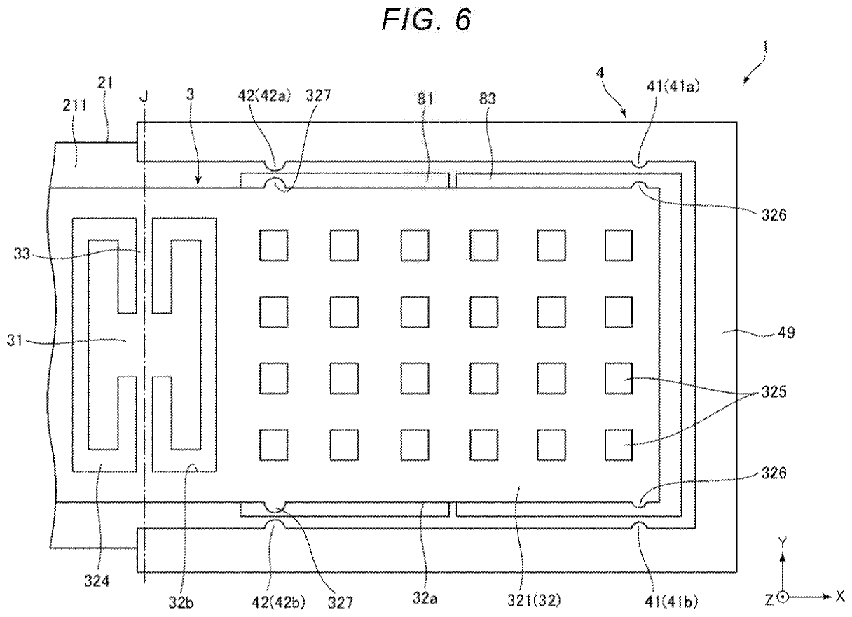

FIG. 6 is a plan view illustrating an inertial sensor according to a second embodiment.

The second embodiment is the same as the first embodiment described above except that the configuration of the stopper 4 is different. In the following description, the second embodiment will be described with a focus on differences from the embodiment described above, and description of similar matters will be omitted. In FIG. 6, the same reference numerals are given to the same configurations as those of the embodiment described above.

As illustrated in FIG. 6, in the inertial sensor 1 of the second embodiment, the second stopper 42 is positioned outside the movable body 32, and is supported by the support portion 49 together with the first stopper 41. That is, in the second embodiment, the first and second stoppers 41 and 42 are both positioned outside the movable body 32. In accordance with this, the protruding portion 327 that contacts the second stopper 42 is provided on the outer peripheral surface 32a of the movable body 32.

As such above, in the second embodiment, the first stopper 41 and the second stopper 42 are positioned outside the movable body 32, respectively. With this configuration, the degree of freedom in design of the first and second stoppers 41 and 42 is increased, and the first and second stoppers 41 and 42 can be disposed at more effective positions, respectively.

According to the second embodiment as described above, the same effects as those of the first embodiment described above can also be exhibited.

### Third Embodiment

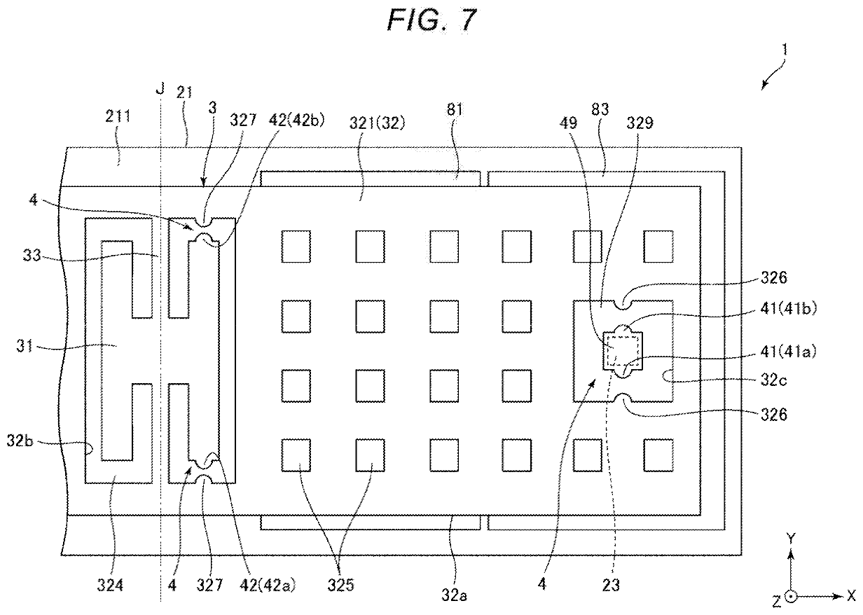

FIG. 7 is a plan view illustrating an inertial sensor according to a third embodiment.

The third embodiment is the same as the first embodiment described above except that the configuration of the stopper 4 is different. In the following description, the third embodiment will be described with a focus on differences from the embodiments described above, and description of similar matters will be omitted. In FIG. 7, the same reference numerals are given to the same configurations as those of the embodiments described above.

As illustrated in FIG. 7, in the inertial sensor 1 of the third embodiment, the first stopper 41 is positioned inside the movable body 32. That is, the first and second stoppers 41 and 42 are both positioned inside the movable body 32. Specifically, the movable body 32 has a through-hole 329 formed at the tip end portion of the first movable portion 321, and the first stopper 41 is positioned in the through-hole 329. With this configuration, since the stopper 4 does not need to be disposed outside the movable body 32, miniaturization of the inertial sensor 1 can be achieved. The support portion 49 that supports the first stopper 41 is fixed to the upper surface of the mount 23 that protrudes from the bottom surface 211 of the concave portion 21.

The first stopper 41 is positioned closer to the tip end side of the first movable portion 321 than the first fixed detection electrode 81, and does not overlap the first fixed detection electrode 81 in plan view from the Z-axis direction. Accordingly, the first stopper 41 can be disposed without sacrificing an area of the first fixed detection electrode 81, that is, without causing a decrease in measurement sensitivity of the acceleration Az. The first stopper 41 faces the inner edge of the movable body 32, that is, the inner peripheral surface 32c of the through-hole 329 in the Y-axis direction. In accordance with this, the protrusion portion 326 that contacts the first stopper 41 is provided on the inner peripheral surface 32c of the through-hole 329.

As such, in the third embodiment, the first stopper 41 and the second stopper 42 are positioned inside the movable body 32, respectively. With this configuration, miniaturization of the inertial sensor 1 can be achieved.

According to the third embodiment as described above, the same effects as those of the first embodiment described above can also be exhibited.

### Fourth Embodiment

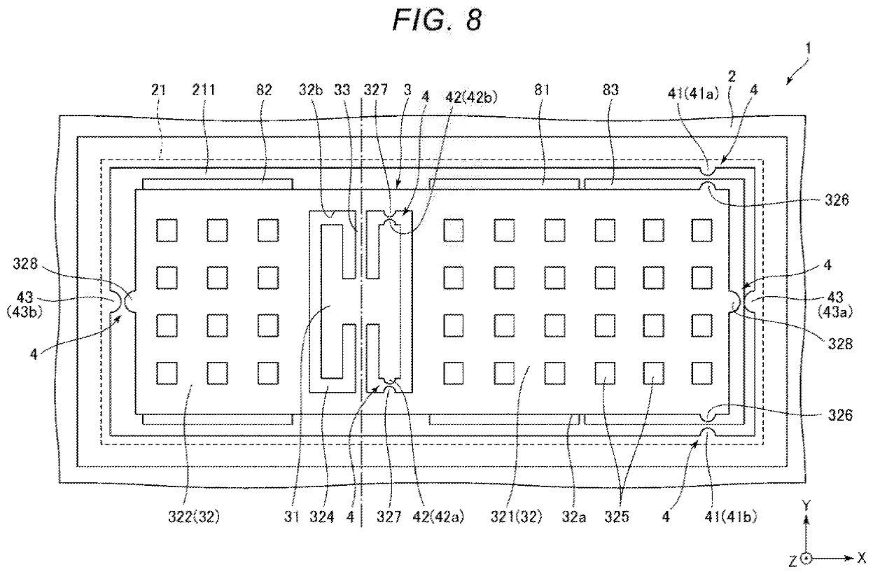

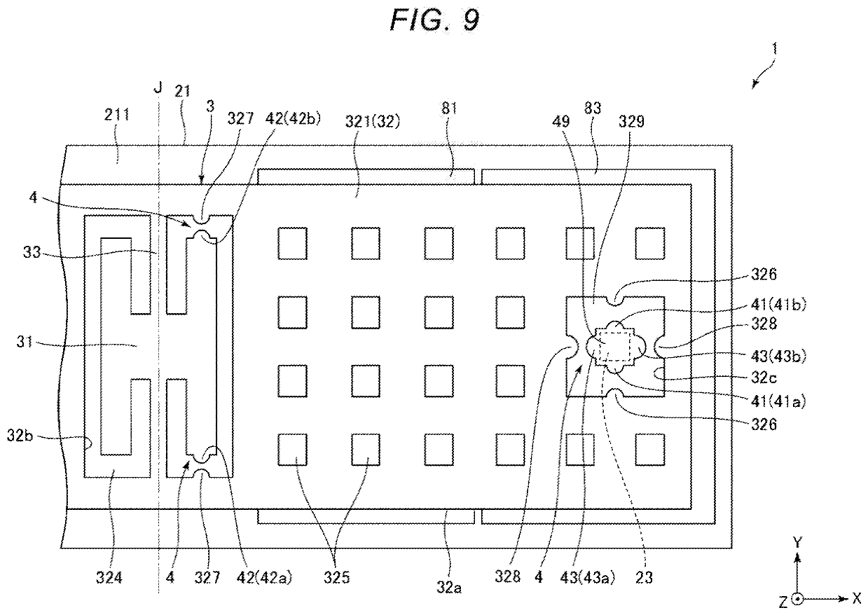

FIG. 8 is a plan view illustrating an inertial sensor according to a fourth embodiment. FIG. 9 is a plan view illustrating a modification example of FIG. 8.

The fourth embodiment is the same as the first embodiment described above except that the configuration of the stopper 4 is different. In the following description, the fourth embodiment will be described with a focus on differences from the embodiments described above, and description of similar matters will be omitted. In FIGS. 8 and 9, the same reference numerals are given to the same configurations as those of the embodiments described above.

As illustrated in FIG. 8, in the inertial sensor 1 of the fourth embodiment, the stopper 4 is supported by the support portion 49 and includes a third stopper 43 that regulates displacement of the movable body 32 in the X-axis direction. With this configuration, unnecessary displacement different from the rotational displacement can be regulated, and unnecessary displacement of the movable body 32 can be more effectively suppressed together with the first and second stoppers 41 and 42. In particular, since the beam 33 has a shape that is easily elastically deformed in the X-axis direction, the movable body 32 is easily displaced in the X-axis direction. For that reason, the effects of providing the third stopper 43 are further increased.

A pair of third stoppers 43 is provided with the movable body 32 interposed therebetween. One third stopper 43a is positioned on the plus side in the X-axis direction with respect to the movable body 32 and faces the tip end portion of the first movable portion 321. A protruding portion 328 protruding from the outer peripheral surface 32a is provided at a portion of the movable body 32 facing the third stopper 43a, and when the movable body 32 is displaced to the plus side in the X-axis direction, the protruding portion 328 comes into contact with the third stopper 43a. On the other hand, the other third stopper 43 b is positioned on the minus side in the X-axis direction with respect to the movable body 32 and faces the tip end portion of the second movable portion 322. The protruding portion 328 protruding from the outer peripheral surface 32a is provided at a portion facing the third stopper 43b of the movable body 32, and when the movable body 32 is displaced to the minus side in the X-axis direction, the protruding portion 328 comes into contact with the third stopper 43b. As such, by disposing the pair of third stoppers 43a and 43b, both the displacement of the movable body 32 to the plus side in the X-axis direction and the displacement to the minus side in the X-axis direction can be regulated.

As such, in the fourth embodiment, the stopper 4 includes the third stopper 43 that faces the movable body 32 along the X-axis. With this configuration, unnecessary displacement different from the rotational displacement can be regulated, and unnecessary displacement of the movable body 32 can be more effectively suppressed together with the first and second stoppers 41 and 42. In particular, since the beam 33 has a shape that is easily elastically deformed in the X-axis direction, the movable body 32 is easily displaced in the X-axis direction. For that reason, the effects of providing the third stopper 43 are further increased.

According to the fourth embodiment as described above, the same effects as those of the first embodiment described above can also be exhibited.

In the fourth embodiment, a configuration in which the third stopper 43 is added to the first embodiment described above is adopted, but is not limited to thereto, and for example, as illustrated in FIG. 9, the third stopper 43 may be added in the third embodiment described above. In this case, each of the third stoppers 43a and 43b is configured to be positioned in the through-hole 329 and to be supported by the support portion 49, and in accordance with this, the protruding portion 328 is provided so as to protrude from the inner peripheral surface 32c of the through-hole 329.

### Fifth Embodiment

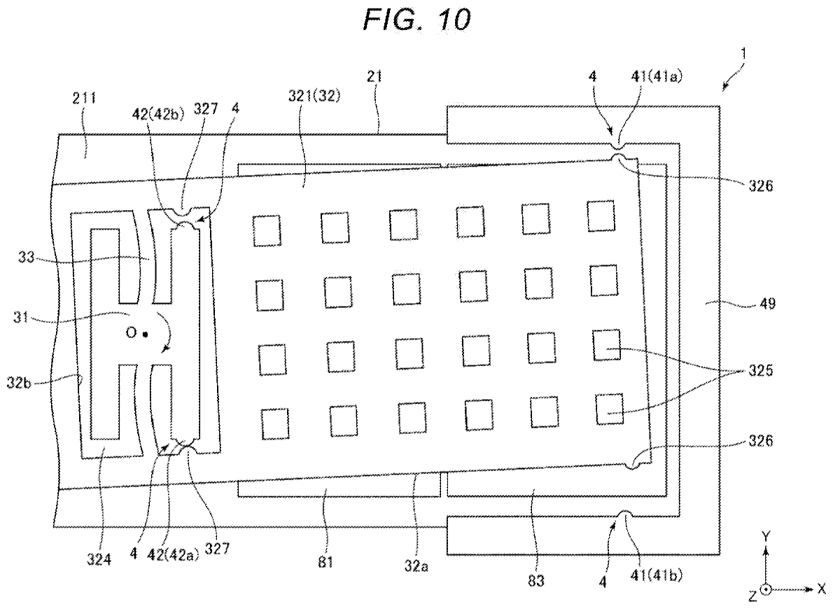

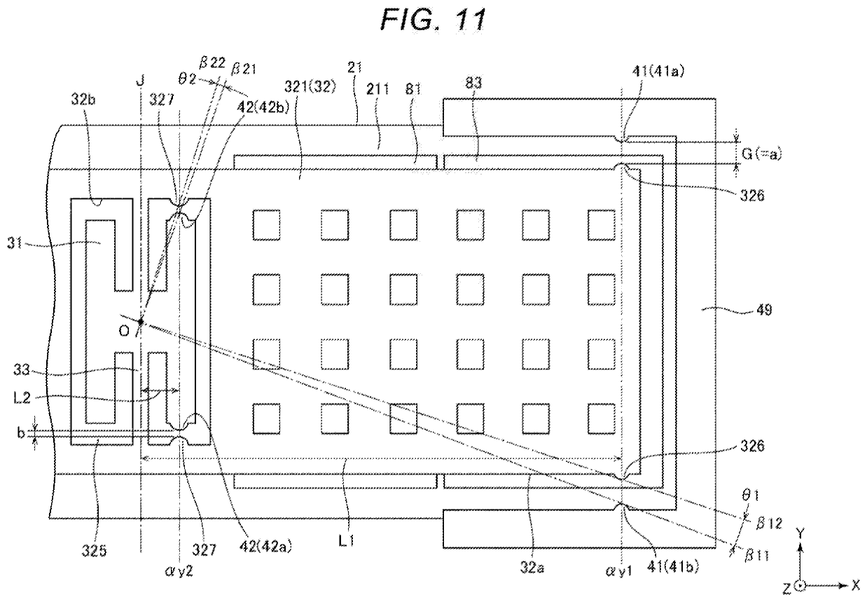

FIG. 10 is a plan view illustrating an inertial sensor according to a fifth embodiment. FIG. 11 is a plan view of the inertial sensor.

The fifth embodiment is the same as the first embodiment described above except that the configuration of the stopper 4 is different. In the following description, the fifth embodiment will be described with a focus on differences from the embodiments described above, and description of similar matters will be omitted. In FIG. 10, the same reference numerals are given to the same configurations as those in the embodiments described above.

In the inertial sensor 1 of the fifth embodiment, when the acceleration Az is applied to the inertial sensor 1 and the movable body 32 is rotationally displaced around the Z-axis, first, as illustrated in FIG. 10, the movable body 32 comes into contact with the second stopper 42 which is proximal from the swing axis J, and thereafter the movable body 32 comes into contact with the first stopper 41 which is distal from the swing axis J.

Since the moment of inertia increases of the movable body 32 as the distance from the center O, which is the center of rotational displacement around the Z-axis of the movable body 32, increases, first, when the second stopper 42, which is on the side with smaller rotational moment, and the movable body 32 come into contact with each other, the impact due to contact can be kept small. Then, after that, when the first stopper 41, which is on the side with greater rotational moment, and the movable body 32 come into contact with each other, the impact at the time of contact between the first stopper 41 and the movable body 32 can be sufficiently reduced. For that reason, while each of the first and second stoppers 41 and 42 exert their functions as a stopper, the impact at the time of contact between the first stopper 41 and the movable body 32 is reduced, and the destruction thereof is effectively suppressed. As a result, the inertial sensor 1 having excellent mechanical strength is obtained.

In the fifth embodiment, as illustrated in FIG. 11, the angle θ1 formed by the line segments β11 and β12 and the angle θ2 formed by the line segments β21 and β22 have a relationship of θ2<θ1. With this configuration, as described above, a configuration in which, when the movable body 32 is rotationally displaced around the Z-axis, the movable body 32 comes into contact with the second stopper 42 first, and then the movable body 32 comes into contact with the first stopper 41 can be adopted. The relationship between θ1 and θ2 is preferably 0.8≤θ2/θ1≤0.98, and more preferably 0.9≤θ2/θ1≤0.98. With this configuration, after the movable body 32 and the second stopper 42 come into contact with each other, the movable body 32 and the first stopper 41 can be brought into contact with each other more reliably. For that reason, it is possible to cause the first stopper 41 to exert its function more reliably as a stopper.

As described above, the inertial sensor 1 of the fifth embodiment includes, assuming that three axes orthogonal to each other are an X-axis, a Y-axis, and a Z-axis, the substrate 2, the movable body 32 that swings around the swing axis J along the Y-axis, the fixed portion 31 that supports the movable body 32 and is fixed to the substrate 2, and the stopper 4 that is fixed to the substrate 2 and regulates rotational displacement around the Z-axis of the movable body 32 by being contacted with the movable body 32. The stopper 4 includes the first stopper 41 facing the movable body 32 along the Y-axis and having a separation distance L1 from the swing axis J and the second stopper 42 facing the movable body 32 along the Y-axis and having a separation distance L2 shorter than the separation distance L1 from the swing axis J. The movable body 32 comes into contact with the second stopper 42 prior to the first stopper 41 when the movable body 32 is rotationally displaced. By adopting such a configuration, the rotational moment of the movable body 32 can be reduced by the contact between the second stopper 42 and the movable body 32, and thus the impact occurs when the first stopper 41 and the movable body 32 come into contact with each other is reduced, and destruction thereof is effectively suppressed. As a result, the inertial sensor 1 having excellent mechanical strength is obtained.

According to the fifth embodiment as described above, the same effects as those of the first embodiment described above can also be exhibited.

### Sixth Embodiment

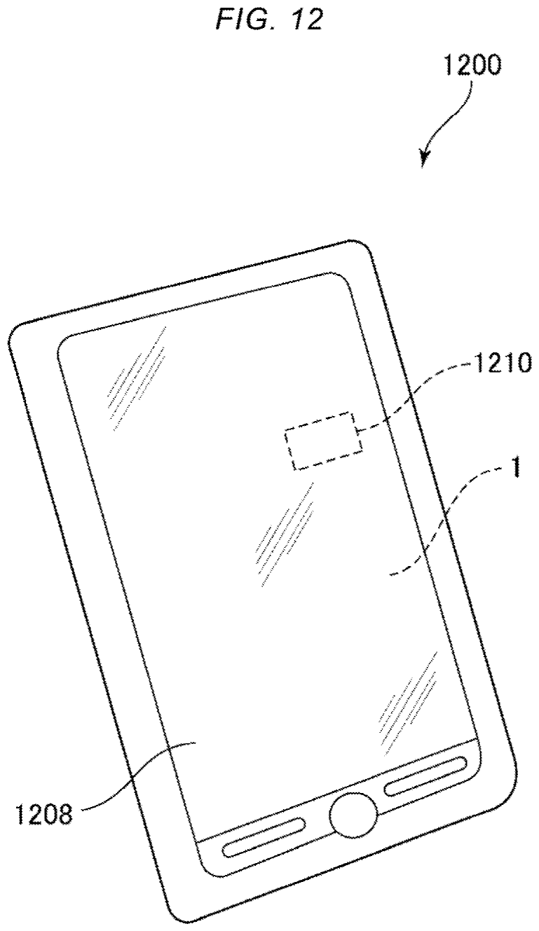

FIG. 12 is a plan view illustrating a smartphone as an electronic device according to a sixth embodiment.

A smartphone 1200 illustrated in FIG. 12 is obtained by applying the electronic device described in the embodiments described above. In the smartphone 1200, the inertial sensor 1 and a control circuit 1210 that performs control based on detection signals output from the inertial sensor 1 are incorporated. Detection data measured by the inertial sensor 1 is transmitted to the control circuit 1210, and the control circuit 1210 can recognize the attitude and behavior of the smartphone 1200 from the received detection data, change a display image displayed on a display unit 1208, generate an alarm sound or sound effect, or drive the vibration motor to vibrate the main body.

The smartphone 1200 as such an electronic device includes an inertial sensor 1 and a control circuit 1210 that performs control based on a detection signal output from the inertial sensor 1. For that reason, the effect of the inertial sensor 1 described above can be obtained, and high reliability can be exhibited.

The electronic device described in the embodiment can be applied to, for example, a personal computer, a digital still camera, a tablet terminal, a clock, a smartwatch, an ink jet printer, a laptop personal computer, a TV, a wearable terminals such as HMD (head mounted display), a video camera, a video tape recorder, a car navigation device, a pager, an electronic datebook, an electronic dictionary, a calculator, an electronic game machines, a word processor, a work station, a videophone, a security TV monitor, an electronic binoculars, a POS terminal, medical equipment, a fish finder, various measuring instruments, mobile terminal base station equipment, various instruments of vehicles, aircraft, and ships, a flight simulator, a network server, and the like, in addition to the smartphone 1200 described above.

### Seventh Embodiment

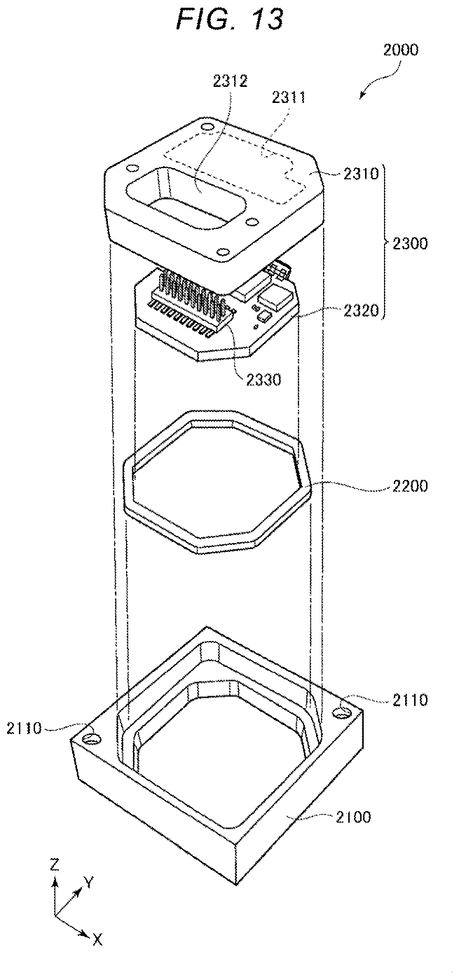

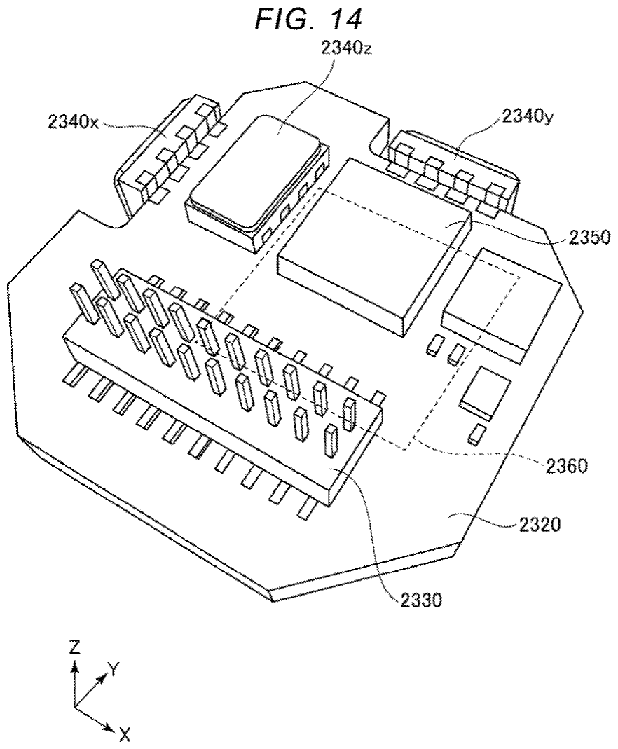

FIG. 13 is an exploded perspective view illustrating an inertia measurement device as an electronic device according to a seventh embodiment. FIG. 14 is a perspective view of a substrate included in the inertial measurement apparatus illustrated in FIG. 13.

An inertia measurement device 2000 (IMU: Inertial Measurement Unit) as an electronic device illustrated in FIG. 13 is an inertia measurement device that detects the attitude and behavior of a mounted device such as an automobile or a robot. The inertia measurement device 2000 functions as a six-axis motion sensor including three-axis acceleration sensors and three-axis angular velocity sensors.

The inertia measurement device 2000 is a rectangular parallelepiped having a substantially square planar shape. Screw holes 2110 as fixed portions are formed in the vicinity of two vertices positioned in the diagonal direction of the square. Through two screws in the two screw holes 2110, the inertia measurement device 2000 can be fixed to the mounted surface of the mounted object such as an automobile. The size of the inertia measurement device 2000 can be reduced such that the device can be mounted on a smartphone or a digital camera, for example, by selection of parts or design change.

The inertia measurement device 2000 has a configuration in which an outer case 2100, a bonding member 2200, and a sensor module 2300 are included and the sensor module 2300 is inserted in the outer case 2100 with the bonding member 2200 interposed therebetween. Similarly to the overall shape of the inertia measurement device 2000 described above, the outer shape of the outer case 2100 is a rectangular parallelepiped having a substantially square planar shape, and screw holes 2110 are formed in the vicinity of two vertices positioned in the diagonal direction of the square. In addition, the outer case 2100 has a box shape and the sensor module 2300 is accommodated therein.

Further, the sensor module 2300 includes an inner case 2310 and a substrate 2320. The inner case 2310 is a member for supporting the substrate 2320, and has a shape that fits inside the outer case 2100. A concave portion 2311 for suppressing contact with substrate 2320 and an opening 2312 for exposing a connector 2330 described later are formed in the inner case 2310. Such an inner case 2310 is bonded to the outer case 2100 through the bonding member 2200. The substrate 2320 is bonded to the lower surface of the inner case 2310 through an adhesive.

As illustrated in FIG. 14, a connector 2330, an angular velocity sensor 2340z for measuring the angular velocity around the Z-axis, an acceleration sensor 2350 for measuring acceleration in each axis direction of the X-axis, the Y-axis, and the Z-axis and the like are mounted on the upper surface of the substrate 2320. An angular velocity sensor 2340x for measuring the angular velocity around the X-axis and an angular velocity sensor 2340y for measuring the angular velocity around the Y-axis are mounted on the side surface of the substrate 2320. As the acceleration sensor 2350, the inertial sensor described in the embodiment can be used.

A control IC 2360 is mounted on the lower surface of the substrate 2320. The control IC 2360 is a micro controller unit (MCU) and controls each unit of the inertia measurement device 2000. In the storing unit, programs defining the order and contents for measuring the acceleration and angular velocity, programs for digitizing detected data and incorporating the detected data into packet data, accompanying data, and the like are stored. In addition, a plurality of electronic components are mounted on the substrate 2320.

### Eighth Embodiment

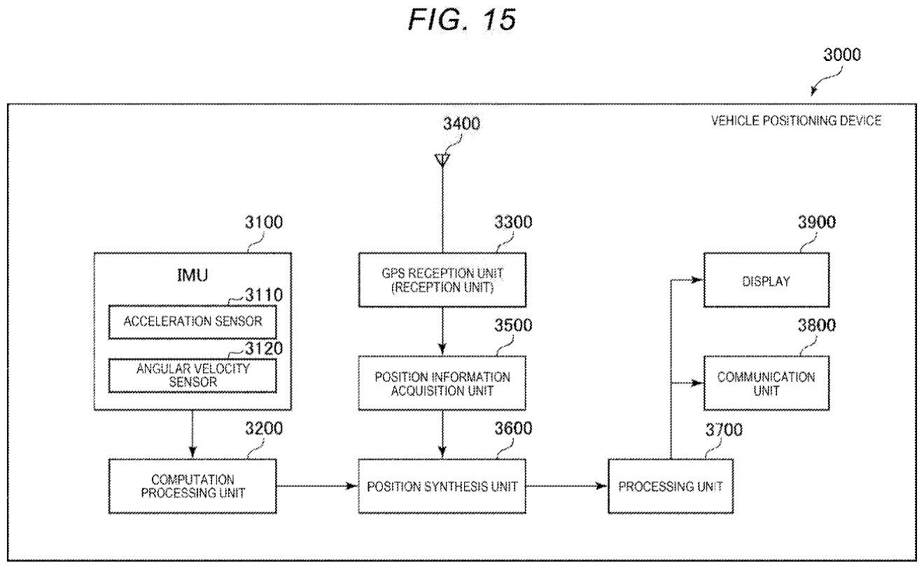

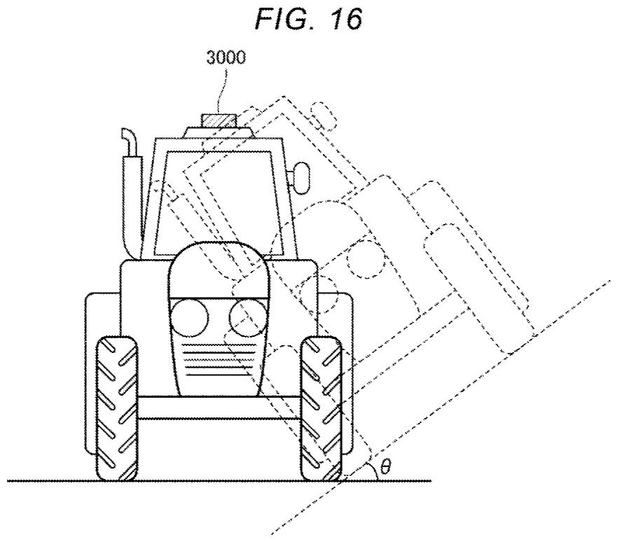

FIG. 15 is a block diagram illustrating an entire system of a vehicle positioning device as an electronic device according to an eighth embodiment. FIG. 16 is a diagram illustrating an operation of the vehicle positioning device illustrated in FIG. 15.

A vehicle positioning device 3000 illustrated in FIG. 15 is a device which is used by being mounted on a vehicle and performs positioning of the vehicle. The vehicle is not particularly limited, and may be any of a bicycle, an automobile, a motorcycle, a train, an airplane, a ship, and the like, but in the eighth embodiment, description will be made on a four-wheeled automobile as the vehicle.

The vehicle positioning device 3000 includes an inertia measurement device 3100 (IMU), a computation processing unit 3200, a GPS reception unit 3300, a receiving antenna 3400, a position information acquisition unit 3500, a position synthesis unit 3600, a processing unit 3700, a communication unit 3800, and a display 3900. As the inertia measurement device 3100, for example, the inertia measurement device 2000 described above can be used.

The inertia measurement device 3100 includes a tri-axis acceleration sensor 3110 and a tri-axis angular velocity sensor 3120. The computation processing unit 3200 receives acceleration data from the acceleration sensor 3110 and angular velocity data from the angular velocity sensor 3120, performs inertial navigation computation processing on these data, and outputs inertial navigation positioning data including acceleration and attitude of the vehicle.

The GPS reception unit 3300 receives a signal from the GPS satellite through the receiving antenna 3400. Further, the position information acquisition unit 3500 outputs GPS positioning data representing the position (latitude, longitude, altitude), speed, direction of the vehicle positioning device 3000 based on the signal received by the GPS reception unit 3300. The GPS positioning data also includes status data indicating a reception state, a reception time, and the like.

Based on inertial navigation positioning data output from the computation processing unit 3200 and the GPS positioning data output from the position information acquisition unit 3500, the position synthesis unit 3600 calculates the position of the vehicle, more specifically, the position on the ground where the vehicle is traveling. For example, even if the position of the vehicle included in the GPS positioning data is the same, as illustrated in FIG. 16, if the attitude of the vehicle is different due to the influence of inclination θ of the ground or the like, the vehicle is traveling at different positions on the ground. For that reason, it is impossible to calculate an accurate position of the vehicle with only GPS positioning data. Therefore, the position synthesis unit 3600 calculates the position on the ground where the vehicle is traveling, using inertial navigation positioning data.

The position data output from the position synthesis unit 3600 is subjected to predetermined processing by the processing unit 3700 and displayed on the display 3900 as a positioning result. Further, the position data may be transmitted to the external apparatus by the communication unit 3800.

### Ninth Embodiment

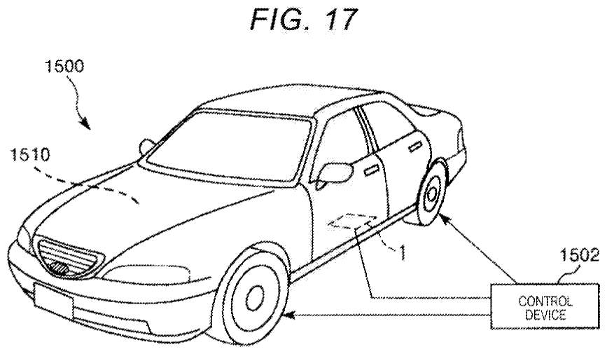

FIG. 17 is a perspective view illustrating a vehicle according to a ninth embodiment.

An automobile 1500 illustrated in FIG. 17 is an automobile to which the vehicle described in the embodiment is applied. In FIG. 17, the automobile 1500 includes at least one system 1510 of an engine system, a brake system, and a keyless entry system. The inertial sensor 1 is incorporated in the automobile 1500, and the attitude of the vehicle body can be measured by the inertial sensor 1. The detection signal of the inertial sensor 1 is supplied to a control device 1502, and the control device 1502 can control the system 1510 based on the signal.

As such, the automobile 1500 as the vehicle includes the inertial sensor 1 and the control device 1502 that performs control based on the detection signal output from the inertial sensor 1. For that reason, the effects of the inertial sensor 1 described above can be obtained and high reliability can be exhibited.

The inertial sensor 1 can also be widely applied to a car navigation system, a car air conditioner, an anti-lock braking system (ABS), an air bag, a tire pressure monitoring system (TPMS), an engine controller, and an electronic control unit (ECU) such as a battery monitor of a hybrid car or an electric automobile. Also, the vehicle is not limited to the automobile 1500, but can also be applied to an airplane, a rocket, a satellite, a ship, an automated guided vehicle (AGV), a biped walking robot, an unmanned airplane such as a drone, and the like.

Although the inertial sensor, the electronic device, and the vehicle according to the present disclosure have been described based on the embodiments, the disclosure is not limited thereto. The configuration of each unit can be replaced with any configuration having the same function. In addition, any other constituent elements may be added to the disclosure. Further, the embodiments described above may be appropriately combined.

What is claimed is:

1. An inertial sensor comprising:
a substrate;
a movable body that swings around a swing axis along a Y-axis;
a fixed portion that supports the movable body and is fixed to the substrate; and
a stopper that is fixed to the substrate and regulates rotational displacement of the movable body around a Z-axis by coming into contact with the movable body, wherein
the stopper includes a first stopper facing the movable body along the Y-axis and having a separation distance L1 from the swing axis and a second stopper facing the movable body along the Y-axis and having a separation distance L2 shorter than the separation distance L1 from the swing axis, and
the movable body comes into contact with the first stopper and the second stopper simultaneously when the movable body is rotationally displaced, wherein
an X-axis, the Y-axis, and the Z-axis are three axes orthogonal to each other.

2. An inertial sensor comprising:
a substrate;
a movable body that swings around a swing axis along a Y-axis;
a fixed portion that supports the movable body and is fixed to the substrate; and
a stopper that is fixed to the substrate and regulates rotational displacement of the movable body around a Z-axis by coming into contact with the movable body, wherein
the stopper includes a first stopper facing the movable body along the Y-axis and having a separation distance L1 from the swing axis and a second stopper facing the movable body along the Y-axis and having a separation distance L2 shorter than the separation distance L1 from the swing axis, and
the movable body comes into contact with the second stopper prior to the first stopper when the movable body is rotationally displaced, wherein
an X-axis, the Y-axis, and the Z-axis are three axes orthogonal to each other.

3. The inertial sensor according to claim 1, further comprising:
a beam that couples the fixed portion and the movable body, wherein
the beam has a thickness in a direction along the Z-axis greater than a width in a direction along the X-axis.

4. The inertial sensor according to claim 1, wherein
each of the first stopper and the second stopper is provided in plural along the Y-axis.

5. The inertial sensor according to claim 1, wherein
the stopper includes a third stopper that faces the movable body along the X-axis.

6. The inertial sensor according to claim 1, wherein
each of the first stopper and the second stopper is positioned outside the movable body.

7. The inertial sensor according to claim 1, wherein
each of the first stopper and the second stopper is positioned inside the movable body.

8. The inertial sensor according to claim 1, wherein
one of the first stopper and the second stopper is positioned outside the movable body and the other is positioned inside the movable body.

9. The inertial sensor according to claim 1, wherein
the movable body includes a first movable portion and a second movable portion that are disposed with the swing axis interposed therebetween and have different rotational moments around the swing axis, and
the inertial sensor further comprises a first fixed detection electrode that is disposed on the substrate and faces the first movable portion and a second fixed detection electrode that is disposed on the substrate and faces the second movable portion.

10. An electronic device comprising:
the inertial sensor according to claim 1; and
a control circuit that performs control based on a detection signal output from the inertial sensor.

11. A vehicle comprising:
the inertial sensor according to claim 1; and
a control device that performs control based on a detection signal output from the inertial sensor.
